(19) United States
(12) Patent Application Publication
(10) Pub. No.: US 2024/0020561 A1
(43) Pub. Date: Jan. 18, 2024

(54) QUANTUM SIMULATOR NETWORK FOR SIMULATING A QUANTUM SERVICE

(71) Applicant: Red Hat, Inc., Raieigh, NC (US)

(72) Inventors: Stephen Coady, Waterford (IE); Leigh Griffin, Waterford (IE)

(73) Assignee: Red Hat, Inc., Raleigh, NC (US)

(21) Appl. No.: 17/864,206

(22) Filed: Jul. 13, 2022

(51) Int. Cl. G06N 10/20; G06N 10/80

(52) U.S. Cl. CPC G06N 10/20; G06N 10/80

(57) ABSTRACT

Examples relating to simulating quantum services are provided. In one example, a quantum service definition file comprising a plurality of instructions is obtained. One or more instruction sets are determined from the plurality of instructions. Each instruction set is communicated to a plurality of quantum simulator nodes. Each quantum simulator node is associated with a different configuration profile for a quantum computing device. For each instruction set, a result set is obtained from each quantum simulator node. The result set includes data indicative of one or more performance metrics associated with an execution of the instruction set by a quantum computing device. A composite result set is determined based at least in part on the result set from each quantum simulator node.

### BACKGROUND

Quantum computing involves the use of quantum bits, referred to herein as “qubits,” which have characteristics that differ from those of classical (i.e., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

### SUMMARY

The examples disclosed herein relate to simulating quantum services using a quantum simulator network. In one example, a method comprises obtaining, by one or more computing devices, a quantum service definition file comprising a plurality of instructions. The method comprises determining, by the one or more computing devices, one or more instruction sets from the plurality of instructions. For each instruction set, the method comprises communicating, by the one or more computing devices, the instruction set to a plurality of quantum simulator nodes, each quantum simulator node associated with a parameter set for a configuration profile for a quantum computing device such that each quantum simulator node is associated with a different configuration profile for the quantum computing device. For each instruction set, the method comprises obtaining, by the one or more computing devices, a result set from each quantum simulator node, the result set includes data indicative of one or more performance metrics associated with an execution of the instruction set by the quantum computing device configured in accordance with the parameter set associated with the quantum simulator node. The method comprises determining, by the one or more computing devices, a composite result set based at least in part on the result set from each quantum simulator node.

In another example, a computing system comprises a memory. The computing system comprises a processor device communicatively coupled to the memory to: obtain a quantum service definition file comprising a plurality of instructions; determine one or more instruction sets from the plurality of instructions; for each instruction set, communicate the instruction set to a plurality of quantum simulator nodes, each quantum simulator node associated with a parameter set for a configuration profile for a quantum computing device such that each quantum simulator node is associated with a different configuration profile for the quantum computing device; for each instruction set, obtain a result set from each quantum simulator node, the result set comprising data indicative of one or more performance metrics associated with a simulated execution of the instruction set by the quantum computing device configured in accordance with the parameter set associated with the quantum simulator node; and determine a composite result set based at least in part on the result set from each quantum simulator node.

In another example, a non-transitory computer readable medium has stored thereon computer-executable instructions. The computer-executable instructions, when executed, cause one or more processor devices to: determine one or more instruction sets from the plurality of instructions; for each instruction set, communicate the instruction set to a plurality of quantum simulator nodes, each quantum simulator node associated with a parameter set for a configuration profile for a quantum computing device such that each quantum simulator node is associated with a different configuration profile for the quantum computing device; for each instruction set, obtain a result set from each quantum simulator node, the result set comprising data indicative of one or more performance metrics associated with a simulated execution of the instruction set by the quantum computing device configured in accordance with the parameter set associated with the quantum simulator node; and determine a composite result set based at least in part on the result set from each quantum simulator node.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts an example system implementing a quantum simulator network for simulating a quantum service according to example implementations of the present disclosure.

FIG. 2 depicts a flow chart of an example method according to example implementations of the present disclosure.

FIG. 3 depicts a flow chart of an example method according to example implementations of the present disclosure.

FIG. 4 depicts a flow chart of an example method according to example implementations of the present disclosure.

FIG. 5 depicts an example system according to example implementations of the present disclosure.

FIG. 6 depicts an example computing device to implement examples according to implementations of the present disclosure.

FIG. 7 depicts an example quantum computing device to implement examples according to implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Finally, it is noted that while, for purposes of illustration and simplicity, the implementations are illustrated as being implemented by computer system that comprises a single computing device that in turn comprises a single processor device, in practice the examples/implementations disclosed herein may be implemented in a computer system that comprises any number of computing devices, each of which may comprise one or more processor devices. Thus, irrespective of the implementation, the examples/implementations may be implemented on a computer system that includes one or more computing devices, wherein the one or more computing devices comprise one or more processor devices, and the one or more processor devices are configured to implement functionality disclosed herein.

Quantum computing involves the use of quantum bits, referred to herein as “qubits,” each of which has properties that differ from those of classical (i.e., non-quantum) bits used in classical computing. A qubit encodes quantum information for an underlying particle such as an atom or a photon, and possesses characteristics that differ from those of classical (i.e., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit. Classical computing has no corollaries to superposition and entanglement.

Qubits may be employed by quantum services executed by quantum computing devices to provide desired functionality. The process for instantiating qubits, placing them into specific quantum states and relationships, storing values using the qubits, and/or subsequently deallocating and reusing the qubits may require the execution of multiple instruction sequences.

Hybrid systems may use a combination of classical computing devices and quantum computing devices to execute quantum services. For instance, quantum simulators implemented using one or more classical processor devices may simulate execution of at least a portion of a quantum service executed on a quantum computing device having qubits. Users may use the quantum simulators to learn more about execution of the quantum service and/or more about the impact on performance of quantum computing devices during execution of the quantum service. In this regard, examples disclosed herein implement a quantum simulator network for simulating execution of a quantum service to provide for enhancement and/or optimization of the quantum service.

More particularly, the quantum simulator network may include a plurality of interconnected quantum simulator nodes. A quantum simulator node is a classical computing service implemented using one or more classical processor devices that simulates execution of a quantum service on quantum hardware. In some implementations, the quantum simulator network may also include actual quantum hardware used to execute the quantum service.

Each quantum simulator node may be configured to simulate a different scenario or configuration profile for a quantum computing device. Each different scenario or configuration profile may be associated with a parameter set defining aspects of the configuration profile, such as hardware characteristics and/or operating characteristics of a quantum computing device. The parameter set may include, for instance, data indicative of number of qubits for a quantum computing device, qubit type, quantum error correction scheme, qubit load, qubit noise profile, or other parameters indicative of configuration or operation of a quantum computing device.

A user may send a request to the quantum simulator network to run a simulated execution of a quantum service at each of the quantum simulator nodes, for instance, by providing a quantum service definition file defining the quantum service. The quantum service definition file may be a quantum assemble (QASM) file. The quantum service definition file may include a plurality of instructions (e.g., lines of code). The quantum simulator network may determine one or more instructions sets from the plurality of instructions. The quantum simulator network may take each instruction set and send it (e.g., in a publication-subscription manner) to each of the quantum simulator nodes.

Each quantum simulator node may run a simulated execution of the instruction set. As a result of these runs, each quantum simulator node may return results indicative of performance metrics associated with execution of the instruction set based on the specific configuration profile of the quantum computing device simulated by the quantum simulator node. The performance metrics may include, for instance, data indicative of operating temperature, qubit availability, processor resource consumption, qubit resource consumption, qubit relaxation time, qubit coherence time or other data associated with performance of the quantum computing device during execution of the instruction set. The quantum simulator node may locally store the result set so that the result sets are available for later simulations of similar instruction sets.

Due to the variety of different configuration profiles, the quantum simulator network may return a plurality of different results indicative of performance metrics, all slightly different depending on the configuration profile simulated by the quantum simulator node. The quantum simulator network may take the returned results and store them in a database.

The quantum simulator network may determine a composite result set associated with execution of the quantum service across all the configuration profiles for the quantum computing device. For instance, in some implementations, the quantum simulator network may use a map function and a reduce function on all the returned results to determine the composite result set. The quantum simulator network may provide the composite result set to the user to allow the user to see the impact of execution of the quantum service across many different quantum hardware profiles and types. In addition, in some implementations, the quantum computing network may modify and/or suggest modifications to the quantum service definition file (e.g., replace one or more instruction sets with different instruction sets) based on the returned results to enhance performance of quantum computing devices when executing the quantum service.

Aspects of the present disclosure may provide technical effects and benefits. For instance, the examples disclosed herein may determine the performance impact of execution of a quantum service by many different types and configurations of quantum computing devices without having to physically execute the quantum service on the quantum computing devices. As a result, the quantum computing devices may use quantum computing resources for functions other than testing and optimization. In addition, the examples disclosed herein may identify potential inefficiencies in a quantum service definition file. For instance, the examples disclosed herein may replace instruction sets with negative impact on performance of quantum computing devices with instructions sets that have reduced impact. In this way, execution of a quantum service may be improved based at least in part on implementation of the quantum simulator network according to example implementations of the present disclosure.

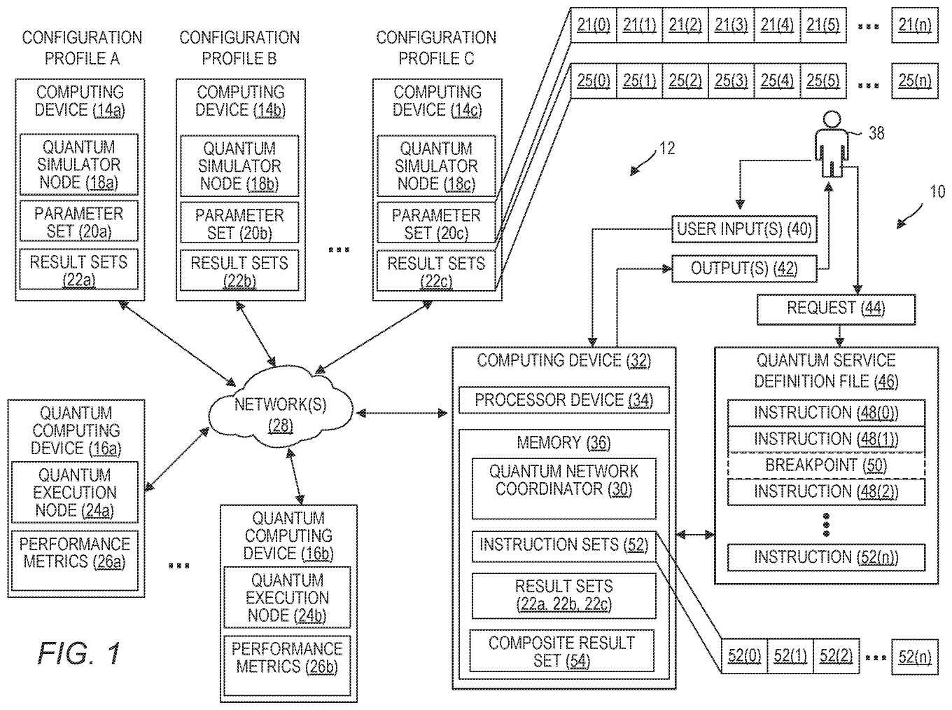

FIG. 1 is a block diagram of a system 10 in which examples may be practiced. The system 10 includes a quantum simulator network 12. The quantum simulator network 12 includes a plurality of interconnected classical computing devices 14a, 14b, . . . 14c and a plurality of quantum computing devices 16a . . . 16b. The example of FIG. 1 illustrates three classical computing devices 14a, 14b, and 14c for purposes of illustration and discussion. The quantum simulator network 12 may have more or fewer classical computing devices without deviating from the scope of the present disclosure.

Similarly, the example of FIG. 1 illustrates two quantum computing devices 16a and 16b for purposes of illustration and discussion. The quantum simulator network 12 may have more or fewer quantum computing devices without deviating from the scope of the present disclosure. In some implementations, the quantum simulator network 12 may have no quantum computing devices and may be implemented entirely using classical computing devices.

Each of the plurality of classical computing devices 14a, 14b, . . . 14c, may be configured to implement a quantum simulator node 18a, 18b, . . . 18c. Each quantum simulator node 18a, 18b, and 18c may be configured to perform a classical simulation of the execution of a quantum service on a quantum computing device. Each quantum simulator node 18a, 18b, and 18c may be implemented, for instance, by a classical processor device executing computer-readable instructions stored in a memory coupled to the processor device.

According to example aspects of the present disclosure, each quantum simulator node 18a, 18b, and 18c may be configured to simulate a different configuration profile of a quantum computing device. For instance, quantum simulator node 18a may be configured to simulate configuration profile A. Quantum simulator node 18b may be configured to simulate configuration profile B. Quantum simulator node 18c may be configured to simulate configuration profile C.

Each configuration profile may be associated with different hardware characteristics and/or operating characteristics of a quantum computing device. Configuration profile A may be different from configuration profile B and configuration profile C. Configuration profile B may be different from configuration profile A and configuration profile C. Configuration profile C may be different from configuration profile A and configuration profile B.

Each different configuration profile may be associated with a parameter set 20a, 20b, 20c defining characteristics of the configuration profile. For instance, quantum simulator node 18a may execute simulations using parameter set 20a to simulate a quantum computing device configured in accordance with configuration profile A. Quantum simulator node 18b may execute simulations using parameter set 20b to simulate a quantum computing device configured in accordance with configuration profile B. Quantum simulator node 18c may execute simulations using parameter set 20c to simulate a quantum computing device in accordance with configuration profile C.

The parameter sets 20a, 20b, and 20c may include, for instance, data 21(0)-21(n). The data 21(0)-21(n) may include, for instance, data indicative of number of qubits for a quantum computing device 21(0), data indicative of qubit type 21(1), data indicative of quantum error correction scheme 21(2), data indicative of qubit load 21(3), data indicative of qubit noise profile 21(4), and/or other data 21(n) indicative of configuration or operation of a quantum computing device.

Each quantum simulator node 18a, 18b, and 18c may be configured to return a result set 22a, 22b, 22c based on the simulation of a quantum service. For instance, quantum simulator node 18a may return result set 22a. Quantum simulator node 18b may return result set 22b. Quantum simulator node 18c may return result set 22c.

Each result set 22a, 22b, and 22c may include data indicative of performance metrics associated with execution of a quantum service (or an instruction set associated with a quantum service) by a quantum computing device configured in accordance with the parameter set 20a, 20b, and 20c associated with the quantum simulator node 18a, 18b, and 18c. More specifically, result set 22a may include data indicative of performance metrics associated with execution of a quantum service (or an instruction set associated with a quantum service) on a quantum computing device configured in accordance with the parameter set 20a associated with quantum simulator node 18a. Result set 22b may include data indicative of performance metrics associated with execution of a quantum service (or an instruction set associated with a quantum service) on a quantum computing device configured in accordance with the parameter set 20b associated with quantum simulator node 18b. Result set 22c may include data indicative of performance metrics associated with execution of a quantum service (or an instruction set associated with a quantum service) on a quantum computing device configured in accordance with the parameter set 20c associated with quantum simulator node 18c.

Each result set 22a, 22b, and 22c may include data 25(0)-25(n). The data 25(0)-25(n) may include, for instance, data indicative of operating temperature 25(0), data indicative of qubit availability 25(1), data indicative of processor resource consumption 25(2), data indicative of qubit resource consumption 25(3), data indicative of qubit relaxation time 25(4), data indicative of qubit coherence time 25(5), and/or other data 25(n).

The quantum computing devices 16a, 16b may have different configuration profiles (e.g., configuration profile A, configuration profile B, configuration profile C, etc.). For instance, the quantum computing devices 16a, 16b may have one or more of a different number of qubits, different qubit type, different type of quantum error correction scheme, different qubit load, different qubit noise profile, or other parameters indicative of configuration or operation of a quantum computing device.

Each of the plurality of quantum computing devices 16a, 16b may be configured to implement a quantum execution node 24a, 24b for the quantum simulator network 12. The quantum execution nodes 24a, 24b may provide for actual execution of a quantum service using quantum hardware (e.g., qubits). The quantum execution nodes 24a, 24b may provide performance metrics 26a, 26b associated with execution of the quantum service (or instruction set associated with a quantum service) by the quantum computing device 16a, 16b. More particularly, the quantum execution node 24a may provide performance metrics 26a associated with execution of the quantum service (or instruction set associated with a quantum service) by the quantum computing device 16a. The quantum execution node 24b may provide performance metrics 26b associated with execution of the quantum service (or instruction set associated with a quantum service) by the quantum computing device 16b.

In some implementations, the performance metrics 26a, 26b may be provided to simulator nodes 18a, 18b, and 18c. The simulator nodes 18a, 18b, and 18c may access the performance metrics 26a, 26b, and 26c when determining result sets 22a, 22b, and 22c during simulation of a quantum service (or instruction set associated with a quantum service).

As illustrated, the computing devices 14a, 14b, 14c and/or the quantum computing devices 16a, 16b may be interconnected via a network 28. The network 28 may include any suitable combination of wired and/or wireless communication links. The network 28 may be and/or may include a local area network, wide area network (e.g., the Internet), or other suitable network. Communication may be carried over the network using any suitable communication protocol or standard.

The quantum simulator network 12 may include a quantum network coordinator 30. The quantum network coordinator 30 is configured to implement functionality disclosed herein to simulate and/or optimize quantum services. The quantum network coordinator 30 may be implemented by a computing device 32 connected to the network 28. The computing device 32 may include a processor device 34. The processor device 34 may be operatively coupled to a memory 36. A user 38 may interact with the quantum network coordinator 30 and quantum simulator network 12 by providing a user input(s) 40 to the computing device 32 and/or receiving output(s) 42 from the computing device via a use suitable user interface (e.g., a graphical user interface presented on a display device).

Because the quantum network coordinator 30 is a component of the computing device 32, functionality implemented by the quantum network coordinator 30 may be attributed to the computing device 32 generally. Moreover, in examples where the quantum network coordinator 30 comprises software instructions that program the processor device 34 to carry out functionality discussed herein; functionality implemented by quantum network coordinator 30 may be attributed herein to the processor device 34.

It is further noted that while the quantum network coordinator 30 is shown as a single component, in other implementations, the quantum network coordinator 30 may be implemented in a plurality of components. Finally, it is noted that while, for purposes of illustration and simplicity, the examples are illustrated as being implemented by a single processor device on a single computing device, in other environments, such as a distributed and/or clustered environment, and where the quantum network coordinator 30 is implemented in multiple components, the quantum network coordinator 30 may be implemented on a computer system that includes a plurality of processor devices of a plurality of different computing devices. Thus, irrespective of the implementation, the examples may be implemented on a computer system that includes one or more processor devices of one or more computing devices.

In some implementations, the user 38 may provide a request 44 to the quantum network controller 30 to simulate a quantum service using the quantum simulator network 12. The request 44 may include a quantum service definition file 46. The quantum service definition file 46 may be a Quantum Assemble (QASM) file, as a non-limiting example. The quantum service definition file 46, may include a plurality of quantum programming instructions 48(0)-48(n) (referred to herein as “instructions” and captioned as “INSTRUCTION” in FIG. 1) for allocating and manipulating qubits to achieve a desired functionality to implement the quantum service. The quantum service definition file 46 may include a breakpoint 50 between instructions 48. The breakpoint 50 may be, for instance, a reserved keyword indicating that execution of the quantum service definition file 46 should be interrupted.

The quantum network coordinator 30 may analyze the quantum service definition file 46 and determine one or more instruction sets 52(0)-52(n) from the plurality of quantum programming instructions. Each instructions set 52(0)-52(n) may include one or more of the instructions 48(0)-48(n). In some implementations, the instruction set 52(0)-52(n) may include all of the instructions 48(0)-48(n) specified in the quantum service definition file 46. In some implementations, the quantum network coordinator 30 may divide the instructions 48(0)-48(n) into smaller instruction sets 52(0)-52(n) (e.g., including one or more of the instructions 48(0)-48(n)) based on the presence of breakpoint(s) 50, information provided by the user 38, line-by-line, or other factors.

The quantum network coordinator 30 may communicate each instruction set 52(0)-52(n) to the quantum simulator network 12. For instance, the quantum network coordinator 30 may communicate each instruction set 52(0)-52(n) to the quantum simulator nodes 18a, 18b, 18c. In some implementations, the quantum network coordinator 30 may communicate each instruction set 52(0)-52(n) to the quantum simulator nodes 18a, 18b, and 18c in a publish-subscribe manner. For instance, the quantum simulator nodes 18a, 18b, and 18c may subscribe to instruction sets 52(0)-52(n) from the quantum network coordinator 30. When the quantum network coordinator 30 determines an instruction set 52(0)-52(n), the quantum network coordinator 30 may publish the instruction set 52(0)-52(n) to the quantum simulator nodes 18a, 18b, and 18c.

The quantum simulator nodes 18a, 18b, and 18c may determine a result set 22a, 22b, 22c including data indicative of performance metrics associated with an execution of the instruction set 52(0)-52(n) by a quantum computing device configured in accordance with the parameter set 20a, 20b, 20c associated with the quantum simulator node 18a, 18b, and 18c.

In some implementations, the quantum network coordinator 30 may communicate the instruction set 52(0)-52(n) to quantum execution nodes 24a, 24b for actual execution by quantum computing devices 16a, 16b. Actual performance metrics 26a, 26b associated with execution of the instruction set 52(0)-52(n) may be provided as result sets to the quantum network coordinator

In addition, the performance metrics 26a, 26b may be communicated to the quantum simulator nodes 18a, 18b, and 18c for use in performing a classical simulation of execution of the result set. For example, in one example implementation, if the quantum computing device 16a is configured in accordance with configuration profile A, the quantum computing device 16a may communicate the performance metrics 26a to the quantum simulator node 18a associated with configuration profile A. The quantum simulator node 18a may store the performance metrics 26a in a memory as a result set 22a (e.g., in a lookup table or other data structure) associated with the instruction set 52(0)-52(n) that generated the performance metrics 26a. When the quantum simulator node 18a performs a classical simulation of execution of the instruction set 52(0)-52(n), the quantum simulator node 18a may access the performance metrics 26a stored as result set 22a in the memory and return the result set 22a.

Similarly, if the quantum computing device 16a is configured in accordance with configuration profile B, the quantum computing device 16a may communicate the performance metrics 26a to the quantum simulator node 18b associated with configuration profile B. The quantum simulator node 18b may store the performance metrics 26a in a memory as a result set 22b (e.g., in a lookup table or other data structure) associated with the instruction set 52(0)-52(n) that generated the performance metrics 26a. When the quantum simulator node 18a performs a classical simulation of execution of the instruction set 52(0)-52(n), the quantum simulator node 18b may access the performance metrics 26a stored as result set 22b in the memory and return the result set 22b.

As one additional example, if the quantum computing device 16b is configured in accordance with configuration profile C, the quantum computing device 16b may communicate the performance metrics 26b to the quantum simulator node 18c associated with configuration profile C. The quantum simulator node 18c may store the performance metrics 26b in a memory as a result set 22c (e.g., in a lookup table or other data structure) associated with the instruction set 52(0)-52(n) that generated the performance metrics 26b. When the quantum simulator node 18c performs a classical simulation of execution of the instruction set 52(0)-52(n), the quantum simulator node 18c may access the performance metrics 26b stored as result set 22c in the memory and return the result set 22c.

The quantum network coordinator 30 may obtain the result sets 22a, 22b, and 22c and may store them in memory 36. The quantum network coordinator 30 may repeat this process for all instruction sets 52(0)-52(n) associated with the quantum service definition file 46.

Once the quantum network coordinator 30 obtains all result sets 22a, 22b, and 22c from each quantum simulator node 18a, 18b, and 18c for each instruction set, the quantum network coordinator 30 may determine a composite result set 54 from the plurality of result sets 22a, 22b, and 22c. The composite result set 54 may provide summary information for all instruction sets 52(0)-52(n) for the quantum service definition file 46 across a variety of different configuration profiles for a quantum computing device. The composite result set can be representative of execution of the quantum service definition file 46 across a plurality of configuration profiles for a quantum computing device(s).

The quantum network coordinator 30 may determine the composite result set 54 using any suitable data processing function or method. In some implementations, the quantum network coordinator 30 may perform a map function on the result sets 22a, 22b, and 22c and a reduce function on the result sets 22a, 22b, and 22c to determine the composite result set 54. The quantum network coordinator 30 may implement other suitable data consolidation algorithms without deviating from the scope of the present disclosure.

The quantum network coordinator 30 may provide the composite result set 54 to the user 38, for instance, as an output 42 of computing device 32 (e.g., as information presented in a graphical user interface). In some implementations, the quantum network coordinator 30 may modify or suggest modifications to the quantum service definition file 46 to improve or optimize execution of the quantum service definition file 46.

For instance, if a particular instruction set 52(0)-52(n) results in poor performance metrics as identified by one of the result sets 22a, 22b, or 22c, the quantum network coordinator 30 may replace the instruction set 52(0)-52(n) with a different instruction set associated with improved performance metrics. The quantum network controller may automatically modify the quantum service definition file 46 or may suggest modifications to the user 38 as an output 42 of the computing device 32 (e.g., as information presented in a graphical user interface).

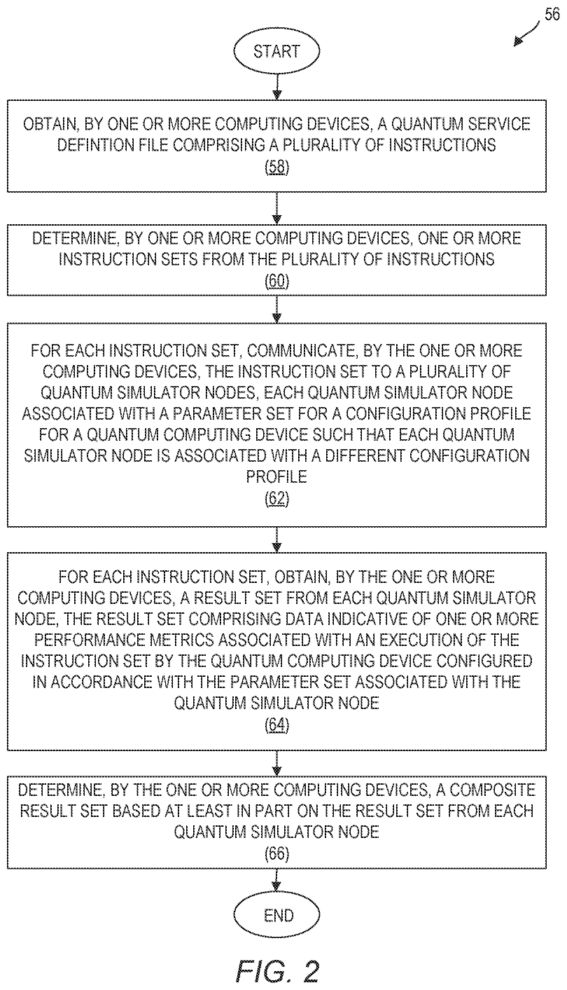

FIG. 2 is a flowchart 56 of an example method according to example implementations of the present disclosure. FIG. 2 may be implemented using one or more computing devices, such as computing device 32 of FIG. 1. Elements of FIG. 1 are referenced in describing FIG. 2 for the sake of clarity. It is to be understood that, in some examples, some operations illustrated in FIG. 2 may be performed in an order other than illustrated herein, include operations not illustrated, and/or may be omitted.

In FIG. 2, the computing device 32 (e.g., the quantum network coordinator 30) may obtain a quantum service definition file 46 comprising a plurality of instructions 48(0)-48(n) (Block 58). For instance, in some implementations, the computing device 32 may access the quantum service definition file 46 stored in memory 36. In some implementations, the computing device 32 may receive a request 44 from a user 38 that includes the quantum service definition file 46.

The computing device 32 may determine one or more instruction sets 52(0)-52(n) from the plurality of instructions 48(0)-48(n) (Block 60). For instance, the computing device 32 may analyze the quantum service definition file 46 to determine the instruction sets 52(0)-52(n). Each instructions set 52(0)-52(n) may include one or more of the instructions 48(0)-48(n). In some implementations, the instruction set 52(0)-52(n) may include all the instructions 48(0)-48(n) specified in the quantum service definition file 46. In some implementations, the computing device may divide the instructions 48(0)-48(n) into smaller instruction sets 52(0)-52(n) (e.g., including one or more of the instructions 48(0)-48(n)) based on the presence of breakpoint(s) 50, information provided by the user 38, line-by-line, or other factors.

For each instruction set 52(0)-52(n), the computing device 32 may communicate the instruction set to a plurality of quantum simulator nodes 18a, 18b, 18c (Block 62). Each quantum simulator node 18a, 18b, 18c is associated with a parameter set 20a, 20b, 20c for a configuration profile for a quantum computing device (e.g., quantum computing device 16a, 16b) such that each quantum simulator node 18a, 18b, 18c is associated with a different configuration profile.

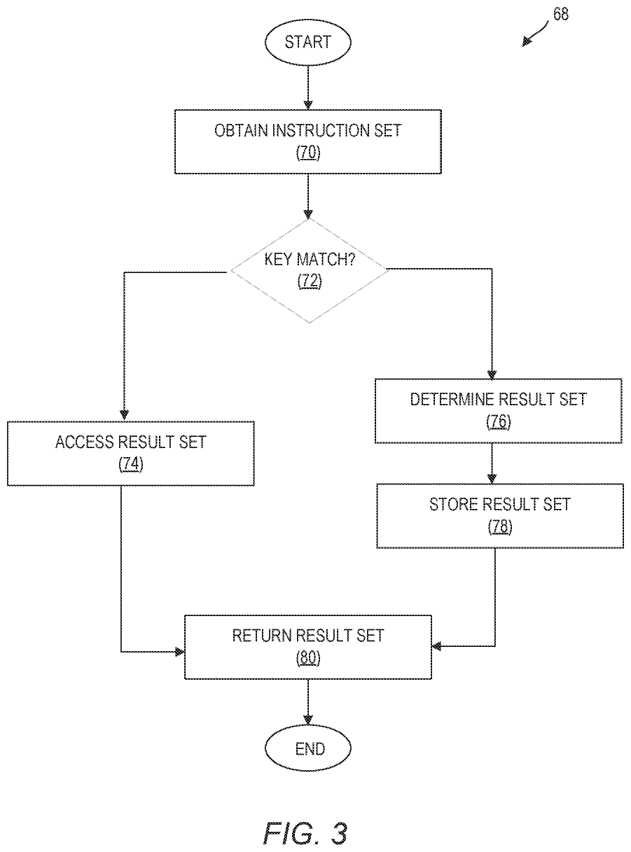

For each instruction set 52(0)-52(n), the computing device 32 may obtain a result set 22a, 22b, 22c from each quantum simulator node 18a, 18b, 18c (Block 64). Each result set 22a, 22b, 22c may be indicative of one or more performance metrics (e.g., performance metrics 26a, 26b) associated with execution of the instruction set 52(0)-52(n) by the quantum computing device (e.g., quantum computing device 16a, 16b) configured in accordance with the parameter set 20a, 20b, 20c associated with the quantum simulator node 18a, 18b, 18c (Block 64). Details concerning determining the result set 22a, 22b, 22c from each quantum simulator node 18a, 18b, 18c are discussed with reference to FIG. 3.

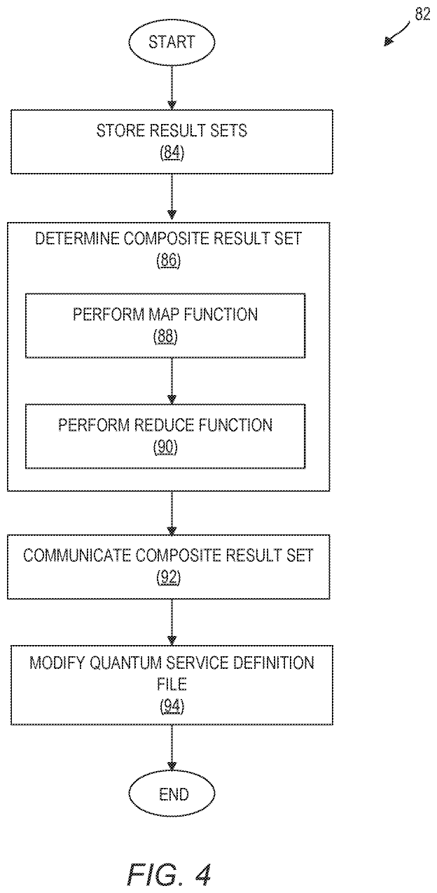

The computing device 32 may determine a composite result set 54 based at least in part on the result set from each quantum simulator node 18a, 18b, 18c (Block 66). The composite result set 54 may provide summary information for all instruction sets 52(0)-52(n) for the quantum service definition file 46 across a variety of different configuration profiles for a quantum computing device. For instance, the composite result set may provide data representative of execution of the quantum service definition file across a plurality of configuration profiles for the quantum computing device. Details concerning determining the composite result set 54 will be discussed with reference to FIG. 4.

FIG. 3 is a flow chart 68 of an example method for determining a result set according to example implementations of the present disclosure. FIG. 3 may be implemented, for instance, by a quantum simulator node, such as quantum simulator node 18a, 18b, 18c. Elements of FIG. 1 are referenced in describing FIG. 3 for the sake of clarity. It is to be understood that, in some examples, some operations illustrated in FIG. 3 may be performed in an order other than illustrated herein, include operations not illustrated, and/or may be omitted.

In FIG. 3, the quantum simulator node 18a, 18b, 18c may obtain an instruction set 52(0)-52(n), for instance, from the quantum network coordinator (Block 70). The quantum simulator node 18a, 18b, 18c may determine whether there is a key match associated with the instruction set 52(0)-52(n). The key match may be indicative of the quantum simulator node 18a, 18b, 18c having previously determined a result set 22a, 22b, 22c for the instruction set 52(0)-52(n). For instance, each instruction set 52(0)-52(n) may be associated with a key or other metadata identifying the instruction set 52(0)-52(n). A key match may occur when the key or other metadata identifying the instruction set 52(0)-52(n) matches a key associated with an instruction set having a previously determined result set 22a, 22b, 22c stored in a memory associated with the quantum simulator node 18a, 18b, 18c. The previously determined result set 22a, 22b, 22c may be from a classical simulation of a quantum computing device or may include actual performance metrics 26a, 26b associated with execution of the instruction set 52(0)-52(n) on a quantum computing device 16a, 16b.

When there is a key match, the quantum simulator node 18a, 18b, 18c may access the previously determined result set 22a, 22b, 22c associated with the instruction set 52(0)-52(n) stored in a memory associated with the quantum simulator node 18a, 18b, 18c (Block 74). The quantum simulator node 18a, 18b, 18c may then return the result set 22a, 22b, 22c to the quantum network coordinator 30 (Block 80).

When there is not a key match, the quantum simulator node 18a, 18b, 18c may determine the result set 22a, 22b, 22c for the instruction set 52(0)-52(n) (Block 76). For instance, in some implementations, the quantum simulator node 18a, 18b, 18c may perform a classical simulation of execution of the instruction set 52(0)-52(n). In some implementations, the quantum simulator node 18a, 18b, 18c may send a request to execute the instruction set to a quantum computing device 16a, 16b configured in accordance with the parameter set 20a, 20b, 20c associated with the quantum simulator node 18a, 18b, 18c. The quantum simulator node 18a, 18b, 18c may receive performance metrics 26a, 26b from the quantum computing device 16a, 16b as the determined result set 22a, 22b, 22c.

Once the quantum simulator node 18a, 18b, 18c determines the result set 22a, 22b, 22c, the quantum simulator node 18a, 18b, 18c may store the result set 22a, 22b, 22c, for instance, in a memory (e.g., local memory or database) (Block 78). In this way, the result set 22a, 22b, 22c may be available for later access by the quantum simulator node 18a, 18b, 18c as a previously determined result set 22a, 22b, 22c, to return to a quantum network coordinator based on a key match. The quantum simulator node 18a, 18b, 18c may then return the result set 22a, 22b, 22c to the quantum network coordinator 30 (Block 80).

FIG. 4 is a flow chart 82 of an example method for determining a composite result set according to example implementations of the present disclosure. FIG. 4 may be implemented, for instance, by one or more computing devices, such as the computing device 32 (e.g., the quantum network coordinator 30). Elements of FIG. 1 are referenced in describing FIG. 4 for the sake of clarity. It is to be understood that, in some examples, some operations illustrated in FIG. 4 may be performed in an order other than illustrated herein, include operations not illustrated, and/or may be omitted.

In FIG. 4, the computing device 32 (e.g., the quantum network coordinator 30) may store result sets 22a, 22b, 22c associated with each instruction set 52(0)-52(n) received from the quantum simulator nodes 18a, 18b, 18c, for instance, in a memory (e.g., in a database) (Block 84). The computing device 32 may determine the composite result set 54 from the result sets 22a, 22b, 22c (Block 86). In some implementations, the computing device 32 may determine the composite result set 54 by performing a map function on the result sets 22a, 22b, 22c (Block 88). The computing device 32 may then perform a reduce function on the result sets 22a, 22b, 22c (Block 90). The computing device 32 may implement other suitable data consolidation algorithms to determine the composite result set 54 from the result sets 22a, 22b, 22c without deviating from the scope of the present disclosure.

The computing device 32 may then communicate the composite result set 54 to a user 38, for instance, as an output 42 of the computing device 32 (Block 92). For instance, the computing device 32 may provide the composite result set for display in a graphical user interface presented on a display device. The computing device 32 may provide the composite result set 54 to a user 38 in other ways without deviating from the scope of the present disclosure (e.g., as an audio output, visual output, printer, etc.).

The computing device 32 may modify the quantum service definition file 46 to improve or optimize execution of the quantum service definition file 46 (Block 94). For instance, if a particular instruction set 52(0)-52(n) results in poor performance metrics as identified by one of the result sets 22a, 22b, or 22c or composite result set 54, the quantum network coordinator 30 may replace the instruction set 52(0)-52(n) with a different instruction set associated with improved performance metrics. The computing device 32 may automatically modify the quantum service definition file 46 or may suggest modifications to the user 38 as an output 42 of the computing device 32 (e.g., as information presented in a graphical user interface).

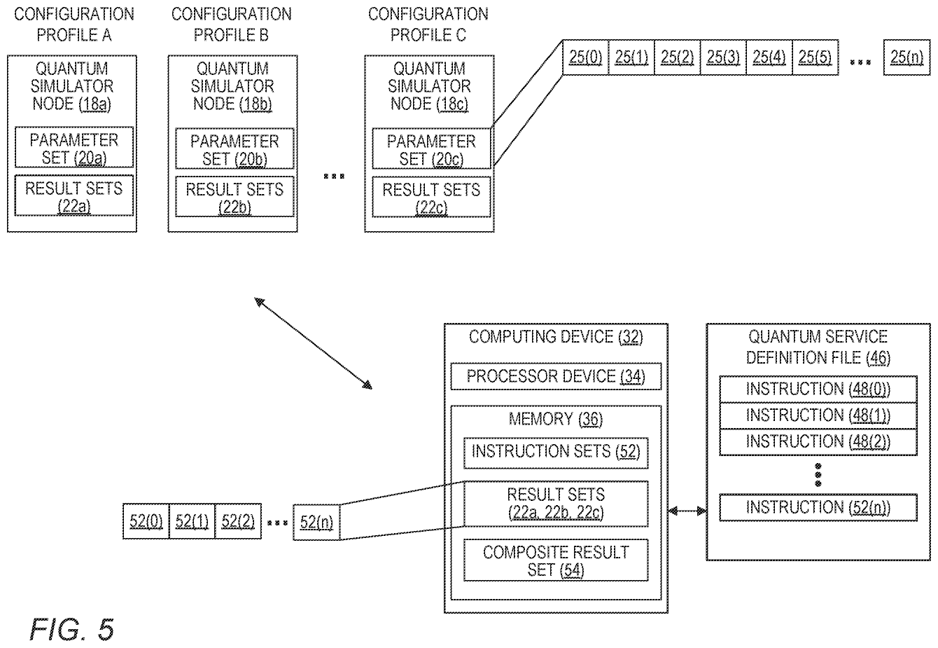

FIG. 5 depicts a simplified diagram of a computing device 32 according to example implementations of the present disclosure. The computing device 32 includes a memory 36. The computing device includes a processor device 34. The processor device 34 is communicatively coupled to the memory 36 to obtain a quantum service definition file 46 having a plurality of instructions 48(0)-48(n). The processor device 34 is communicatively coupled to the memory 36 to determine one or more instruction sets 52(0)-52(n) from the plurality of instructions 48(0)-48(n). The processor device 34 is communicatively coupled to the memory 36 such that for each instruction set 52(0)-52(n), the processor device 34 communicates the instruction set to a plurality of quantum simulator nodes 18a, 18b, 18c. Each quantum simulator node 18a, 18b, 18c is associated with a parameter set 20a, 20b, 20c for a configuration profile (e.g., configuration profile A, configuration profile B, configuration profile C) for a quantum computing device such that each quantum simulator node 18a, 18b, 18c is associated with a different configuration profile for the quantum computing device. The processor device 34 is communicatively coupled to the memory 36 such that for each instruction set 52(0)-52(n), the processor device 34 obtains a result set 22a, 22b, 22c from each quantum simulator node 18a, 18b, 18c. The result set 22a, 22b, 22c includes data 25(0)-25(n) indicative of one or more performance metrics associated with a simulated execution of the instruction set 52(0)-52(n) by the quantum computing device in accordance with the parameter set 20a, 20b, 20c associated with the quantum simulator node 18a, 18b, 18c. The processor device 34 is communicatively coupled to the memory 36 to determine a composite result set 54 based at least in part on the result set 22a, 22b, 22c from each quantum simulator node 18a, 18b, 18c.

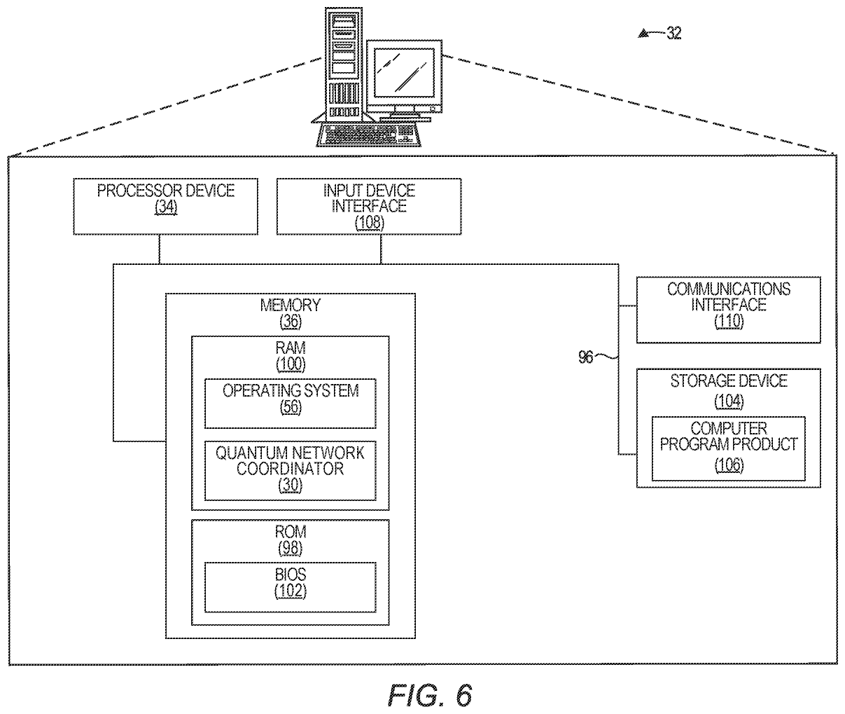

FIG. 6 is a block diagram of the computing device 32 suitable for implementing examples according to one example. FIG. 6 is representative of computing device 32 for purposes of illustration. FIG. 6 can also be representative of other computing devices, such as computing devices 14a, 14b, 14c of FIG. 1. The computing device 32 may comprise any computing or electronic device capable of including firmware, hardware, and/or executing software instructions to implement the functionality described herein, such as a computer server, a desktop computing device, a laptop computing device, or the like. The computing device 32 includes the processor device 34, the memory 36, and a system bus 96. The system bus 96 provides an interface for system components including, but not limited to, the memory 36 and the processor device 34. The processor device 34 can be any commercially available or proprietary processor.

The memory 36 may include non-volatile memory 98 (e.g., read-only memory (ROM), erasable programmable read-only memory (EPROM), electrically erasable programmable read-only memory (EEPROM), etc.), and volatile memory 100 (e.g., random-access memory (RAM)). A basic input/output system (BIOS) 102 may be stored in the non-volatile memory 98 and can include the basic routines that help to transfer information between elements within the computing device 32. The volatile memory 100 may also include a high-speed RAM, such as static RAM, for caching data.

The computing device 32 may further include or be coupled to a non-transitory computer-readable storage medium such as the storage device 104, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 104 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 104 and in the volatile memory 100, including an operating system and one or more program modules, such as the quantum network coordinator 30, which may implement the functionality described herein in whole or in part.

All or a portion of the examples may be implemented as a computer program product 106 stored on a transitory or non-transitory computer-usable or computer-readable storage medium, such as the storage device 104, which includes complex programming instructions, such as complex computer-readable program code, to cause the processor device 34 to carry out the steps described herein. Thus, the computer-readable program code can comprise software instructions for implementing the functionality of the examples described herein when executed on the processor device 34. The processor device 34, in conjunction with the quantum network coordinator 30 in the volatile memory 100, may serve as a controller, or control system, for the computing device 32 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 34 through an input device interface 108 that is coupled to the system bus 96 but can be connected by other interfaces such as a parallel port, an Institute of Electrical and Electronic Engineers (IEEE) 1394 serial port, a Universal Serial Bus (USB) port, an IR interface, and the like.

The computing device 32 may also include a communications interface 110 suitable for communicating with the network 28 (FIG. 1) or other devices as appropriate or desired.

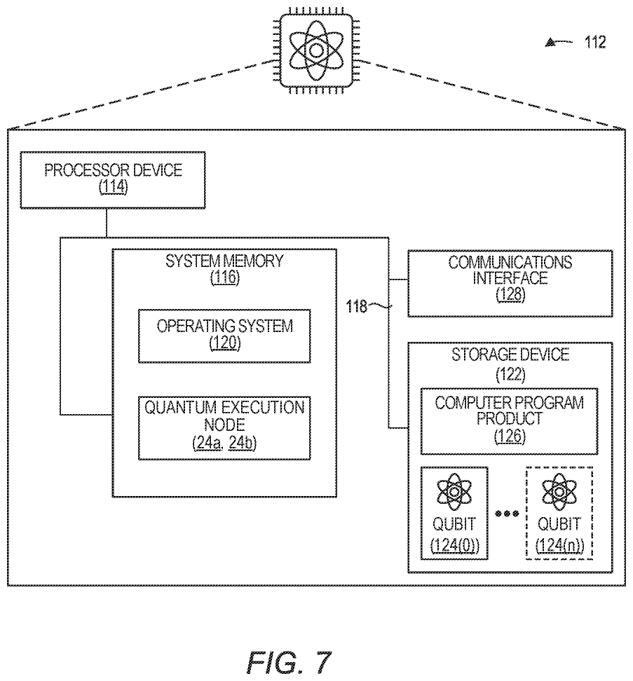

FIG. 7 is a block diagram of a quantum computing device 112 suitable for implementing examples according to example implementations, such as the quantum computing devices 16a, 16b of FIG. 1. The quantum computing device 112 may comprise any computing or electronic device capable of including firmware, hardware, and/or executing software instructions to implement the functionality described herein in a quantum environment. The quantum computing device 112 includes one or more processor device(s) 114, one or more memory device(s) 116 and a system bus 118. The system bus 118 provides an interface for system components including, but not limited to, the one or more memory device(s) 116 and the one or more processor device(s) 114. The one or more processor device(s) 114 may be any commercially available or proprietary processor suitable for operating in a quantum environment. The one or more memory device(s) 116 may store computer-readable instructions associated with an operating system 120 and/or a quantum execution node 24a, 24b.

The quantum computing device 112 may further include or be coupled to a non-transitory computer-readable storage medium such as a storage device 123. The storage device 122 and other drives associated with computer-readable media and computer-usable media may provide non-volatile storage of data, data structures, computer-executable instructions, and the like. The storage device 120 may also store one or more qubits 124(0)-124(n), which may be measured and/or manipulated by the one or more processor device(s) 114 when performing quantum computing operations.

All or a portion of the examples may be implemented as a computer program product 126 stored on a transitory or non-transitory computer-usable or computer-readable storage medium, such as the storage device 122, which includes complex programming instructions, such as complex computer-readable program code, to cause the one or more processor devices 114 to carry out the functionality described herein. Thus, the computer-readable program code may comprise software instructions for implementing the functionality of the examples described herein when executed on the one or more processor devices 114.

An operator may also be able to enter one or more configuration commands through a keyboard (not illustrated), a pointing device such as a mouse (not illustrated), or a touch-sensitive surface (not illustrated). The quantum computing device 112 may also include a communications interface 128 suitable for communicating with other computing devices, including, in some implementations, classical computing devices and/or quantum computing devices.

The examples also facilitate an improvement to computer functionality itself by providing a federated messaging mechanism to intelligently route quantum information transmitted over a communications network among quantum computing devices, resulting in improved functionality of computing devices on the communications network. Thus, the examples are directed to specific improvements in computer functionality.

What is claimed is:

1. A method, comprising:
obtaining, by one or more computing devices, a quantum service definition file comprising a plurality of instructions;
determining, by the one or more computing devices, one or more instruction sets from the plurality of instructions;
for each instruction set, communicating, by the one or more computing devices, the instruction set to a plurality of quantum simulator nodes, each quantum simulator node associated with a parameter set for a configuration profile for a quantum computing device such that each quantum simulator node is associated with a different configuration profile for the quantum computing device;
for each instruction set, obtaining, by the one or more computing devices, a result set from each quantum simulator node, the result set comprising data indicative of one or more performance metrics associated with an execution of the instruction set by the quantum computing device configured in accordance with the parameter set associated with the quantum simulator node; and
determining, by the one or more computing devices, a composite result set based at least in part on the result set from each quantum simulator node.

2. The method of claim 1, wherein the parameter set comprises data indicative of one or more of a number of qubits, qubit type, quantum error correction scheme, qubit load, or qubit noise profile.

3. The method of claim 1, wherein the one or more performance metrics for a result set comprises data indicative of one or more of operating temperature, qubit availability, processor resource consumption, qubit resource consumption, qubit relaxation time, or qubit coherence time.

4. The method of claim 1, wherein for each instruction set, the result set obtained from each quantum simulator node is obtained based at least in part by obtaining data associated with a classical simulation of the quantum computing device configured in accordance with the parameter set associated with the simulator node.

5. The method of claim 4, wherein for each instruction set, the result set obtained from each quantum simulator node is determined based at least in part on a key match associated with the instruction set at the quantum simulator node.

6. The method of claim 1, wherein the composite result set is representative of execution of the quantum service definition file across a plurality of configuration profiles for the quantum computing device.

7. The method of claim 1, wherein determining, by the one or more computing devices, a composite result set based at least in part on the result set from each quantum simulator node, comprises:
storing, by the one or more computing devices, the result set from each quantum simulator node in memory;
performing, by the one or more computing devices, a map function on the result set stored in the memory; and
performing, by the one or more computing devices, a reduce function on the result set stored in the memory.

8. The method of claim 1, wherein the method comprises modifying, by the one or more computing devices, the quantum service definition file based at least in part on the composite result set.

9. A computing device, comprising:
a memory; and
a processor device communicatively coupled to the memory to:
obtain a quantum service definition file comprising a plurality of instructions;
determine one or more instruction sets from the plurality of instructions;
for each instruction set, communicate the instruction set to a plurality of quantum simulator nodes, each quantum simulator node associated with a parameter set for a configuration profile for a quantum computing device such that each quantum simulator node is associated with a different configuration profile for the quantum computing device;
for each instruction set, obtain a result set from each quantum simulator node, the result set comprising data indicative of one or more performance metrics associated with a simulated execution of the instruction set by the quantum computing device configured in accordance with the parameter set associated with the quantum simulator node; and
determine a composite result set based at least in part on the result set from each quantum simulator node.

10. The computing device of claim 9, wherein the parameter set for a quantum computing device comprises data indicative of one or more of number of qubits, qubit type, quantum error correction scheme, qubit load, or qubit noise profile.

11. The computing device of claim 9, wherein the one or more performance metrics obtained from each quantum simulator node comprise data indicative of one or more of operating temperature, qubit availability, processor resource consumption, qubit resource consumption, qubit relaxation time, or qubit coherence time.

12. The computing device of claim 9, wherein for each instruction set, the result set obtained from each quantum simulator node is obtained based at least in part by obtaining data associated with a classical simulation of the quantum computing device configured in accordance with the parameter set associated with the simulator node.

13. The computing device of claim 12, wherein for each instruction set, the result set obtained from each quantum simulator node is determined based at least in part on a key match associated with the instruction set at the quantum simulator node.

14. The computing device of claim 9, wherein the composite result set is representative of execution of the quantum service definition file across a plurality of configuration profiles for the quantum computing device.

15. The computing device of claim 9, wherein the processor device is further to modify the quantum service definition file based at least in part on the composite result set.

16. A non-transitory computer-readable storage medium having stored thereon computer-executable instructions that, when executed, cause one or more processor devices to:
obtain a quantum service definition file comprising a plurality of instructions;
determine one or more instruction sets from the plurality of instructions;
for each instruction set, communicate the instruction set to a plurality of quantum simulator nodes, each quantum simulator node associated with a parameter set for a configuration profile of a quantum computing device such that each quantum simulator node is associated with a different configuration profile for the quantum computing device;
for each instruction set, obtain a result set from each quantum simulator node, the result set comprising data indicative of one or more performance metrics associated with a simulated execution of the instruction set by the quantum computing device configured in accordance with the parameter set associated with the quantum simulator node; and
determine a composite result set based at least in part on the result set from each quantum simulator node.

17. The non-transitory computer-readable storage medium of claim 16, wherein the parameter set for a quantum computing device comprises data indicative of one or more of number of qubits, qubit type, quantum error correction scheme, qubit load, or qubit noise profile.

18. The non-transitory computer-readable storage medium of claim 16, wherein the one or more performance metrics obtained from each quantum simulator node comprise data indicative of one or more of operating temperature, qubit availability, processor resource consumption, qubit resource consumption, qubit relaxation time, or qubit coherence time.

19. The non-transitory computer-readable storage medium of claim 16, wherein the computer-executable instructions further cause the one or more processor devices to modify the quantum service definition file based at least in part on the composite result set.

20. The non-transitory computer-readable storage medium of claim 16, wherein the composite result set is representative of execution of the quantum service definition file across a plurality of configuration profiles for the quantum computing device.
